(19) United States
(12) Patent Application Publication
(10) Pub. No.: US 2019/0187008 A1
(43) Pub. Date: Jun. 20, 2019

(54) Sensor Head For a Force or Torque Sensor

(71) Applicant: Trafag AG, Bubikon (CH)

(72) Inventors: Christoph Schanz, Rickenhausen (DE); Dieter Zeisel, Forch (CH)

(21) Appl. No.: 16/320,846

(22) PCT Filed: Jul. 25, 2017
(86) PCT No.: PCT/EP2017/068814

§ 371 Date: Jan. 25, 2019

(30) Foreign Application Priority Data
Jul. 25, 2016 (DE) 10 2016 113 689.1
Nov. 17, 2016 (DE) 10 2016 122 172.4

(51) Int. Cl. G01L 1/12; G01L 3/10; B29C 45/14

(52) U.S. Cl. CPC G01L 1/127; B29L 2031/3425; B29C 45/14819; G01L 3/105

(57) ABSTRACT

In order to enable practical suitability of a force or torque sensor and usability for a variety of applications in conjunction with cost-effective production, the invention provides a sensor head (10) for a magnetoelastic force or torque sensor for measuring a force or a torque in a ferromagnetic body (9), comprising: a magnetic field generating unit (14) for generating a magnetic field in the ferromagnetic body (9) and a magnetic field measuring unit (16) for measuring a magnetic field change in the ferromagnetic body (9), wherein the magnetic field generating unit (14) has an excitation coils (18) and a soft-magnetic excitation flux amplifying element (20), wherein the magnetic field measuring unit (16) has a plurality of measurement coil (22) with a soft-magnetic measurement flux amplifying element (24), wherein at least the excitation coil (18) and the measurement coils (22, 22a-22d) are integrated in a common integrated component, such as, in particular, a printed circuit board element (26) and/or MEMS component (28).

The invention relates to a sensor head for a magnetoelastic force or torque sensor for measuring a force or a torque in a ferromagnetic body.

Magnetoelastic force sensors or torque sensors are known for example from U.S. Pat. No. 2,912,642, DE 30 31 997 A1 or U.S. Pat. No. 4,503,714 or from EP 0 136 086 A2. Further magnetoelastic force or torque sensors are described in EP 2 397 829 B1 or EP 2 615 422 B1.

In sensors of this type, the force measurement or torque measurement is carried out by means of the magnetoelastic effect. Magnetic materials exhibit a close interaction between their magnetic and mechanical properties. In this regard, magnetic field lines of a magnetic field induced in a ferromagnetic body are altered by loadings of the body.

Magnetoelastic sensors thus generally have a magnetic field generating unit for generating a magnetic field in the ferromagnetic body and a measuring device for measuring a magnetic field change under loading.

Here there are essentially two basic principles for constructing the respective sensor head.

In a first construction, such as is shown for example in U.S. Pat. No. 2,912,642, the magnetic field is generated at a magnetic field yoke having magnetic field generating coils, wherein a measurement yoke with measurement coils is arranged in a direction crossing the magnetic field generating yoke. In the second possible construction, such as is shown in DE 30 31 997 or EP 0 136 086, FIG. 9A therein, an excitation coil is arranged centrally around an excitation coil core situated centrally between magnetic poles of the magnetic field measuring unit. In this case, the cores can be connected by a soft-magnetic material.

In particular, the magnetic field generating unit has a flux concentrator having a soft-magnetic excitation core that is led through an excitation coil.

Magnetoelastic sensors exhibit very good measurement results in the laboratory. Although this measurement principle has already been known for decades, it has scarcely found application in practice.

The invention has set itself the object of eliminating this circumstance and constructing force measuring sensors according to the magnetoelastic principle and torque measuring sensors which are producible in a cost-effective manner and are suitable for a variety of practical applications.

For this purpose, a sensor head according to Claim 1 and a method for producing a sensor head according to the alternative independent claim are proposed.

The dependent claims relate to advantageous configurations.

In accordance with a first aspect, the invention provides a sensor head for a magnetoelastic force or torque sensor for measuring a force or a torque in a ferromagnetic body, comprising:

a magnetic field generating unit for generating a magnetic field in the ferromagnetic body and a magnetic field measuring unit for measuring a magnetic field change in the ferromagnetic body,
wherein the magnetic field generating unit has an excitation coil and a soft-magnetic excitation flux amplifying element,
wherein the magnetic field measuring unit has a plurality of measurement coils with a soft-magnetic measurement flux amplifying element,
wherein at least the excitation coil and the measurement coils are integrated in a common integrated component.

One embodiment of the invention provides a sensor head for a magnetoelastic force or torque sensor for measuring a force or a torque in a ferromagnetic body, comprising:

a magnetic field generating unit for generating a magnetic field in the ferromagnetic body and a magnetic field measuring unit for measuring a magnetic field change in the ferromagnetic body,
wherein the magnetic field generating unit has an excitation coil around a soft-magnetic excitation core,
wherein the magnetic field measuring unit has a plurality of measurement coils with a soft-magnetic measurement core,
wherein at least the excitation coil and the measurement coils are integrated at a common integrated component.

In accordance with one preferred configuration, the integrated component is a printed circuit board element. In accordance with a further configuration, the integrated component is a MEMS component.

Advantageously, provision is made for the coils to be formed using printed circuit board technology at a printed circuit board element. However, other possibilities for jointly integrally constructing the coils in a component are also conceivable, such as MEMS techniques, semiconductor manufacturing techniques or additive manufacturing methods.

In one exemplary embodiment, the coils are constructed from planar coils which are formed in a conductor layer of the integrated component. A plurality of conductor layers provided with planar coils can be combined with correspondingly insulating interlayers to form a coil assembly.

Preferably, for this purpose, in a conductor layer, a planar coil for forming at least one part of a first measurement coil and a planar coil for forming a second measurement coil and/or an excitation coil are arranged in one plane. By arranging a plurality of such conductor layers with a plurality of planar coils, at the same time coil assemblies for forming a first measurement coil and a second measurement coil and/or an excitation coil can be constructed simultaneously.

Hitherto the coils have been wound in a complex fashion and have been one of the largest cost factors for sensor heads of this type. With the invention, considerable labor and considerable costs can be saved by means of integrated manufacturing of the coils. Moreover, the sensor head or at least the coil unit thereof can thus be manufactured industrially in mass production. The coil unit can be constructed very compactly. Packaging methods for protecting the sensor head can advantageously be carried out.

In one configuration with construction using printed circuit board technology, a printed circuit board element having a conductive layer and a carrier layer formed from an insulator is provided, and then at least one planar coil is produced at the conductive layer, e.g. by means of lithographic techniques. A plurality of such printed circuit boards can be stacked to form an assembly, wherein the individual conductor layers with the planar coil parts can be contacted through vias. Magnetic cores can be formed by forming cavities and filling them with ferromagnetic material.

In an alternative design, insulator layers and conductor structures for forming the coils are constructed layer by layer using additive manufacturing techniques and/or using techniques known from semiconductor technology for the construction of integrated circuits. Here too, construction can advantageously take place such that conductor layers are applied in a patterned fashion in a common plane in a such a way that a plurality of planar coils are formed alongside one another in order to form a first measurement coil and a second measurement coil and/or an excitation coil. A plurality of such layers provided with planar coils with insulation layers therebetween can be constructed to form coil assemblies. This can be done additively layer by layer, or individual boards having at least one conductor layer with planar coil regions and an insulation layer are constructed and then connected to one another to form an assembly. Here, too, there may be passages through the insulation layers for electrical connection by means of conductive vias. Magnetic cores can also be applied by corresponding material application, e.g. using mask technology or by means of powder application and laser sintering. Alternatively, cavities can be manufactured and filled with soft-magnetic materials.

It is preferred for the measurement cores of a first measurement coil and of a second measurement coil to be connected in order to form a magnetic circuit by means of a yoke composed of soft-magnetic material.

It is preferred for the yoke to be at least partly incorporated or integrated into the integrated component. In particular, the yoke is incorporated in a printed circuit board or integrated in a MEMS component.

It is preferred for the excitation core to form a flux concentrator, which is arranged as a central magnetic pole between at least two measurement coils.

It is preferred for the excitation core to be contact-connected to the yoke.

It is preferred for at least one ferritic film to be provided.

It is preferred for the ferritic film to have a thickness of 0.1 mm to 3 mm, in particular 0.1 mm to 0.5 mm or 1 mm to 2 mm.

It is preferred for the ferritic film to be embedded into the integrated component and/or to be applied on the component and/or to be fitted, in particular to be adhesively bonded, onto a printed circuit board at which the coils are formed.

It is preferred for the at least one ferritic film to form at least one part of one of the soft-magnetic flux amplifying elements.

It is preferred for the excitation core and/or the measurement cores and/or the yoke to be formed by the at least one ferritic film.

Preferably, the sensor head comprises a first integrated component, such as in particular a first printed circuit board element or a first MEMS component, at which at least the excitation coil and a plurality of measurement coils are provided in an integrated fashion in such a way that a plurality of magnetic poles are formed, and a second integrated component, such as in particular a second printed circuit board element or a second MEMS component, into which is incorporated or integrated at least one soft-magnetic material for connecting and/or forming soft-magnetic flux amplifying elements such as, in particular, cores of the magnetic poles, wherein the first and second integrated components are connected to one another.

Preferably, the sensor head comprises an integrated circuit having a signal processing electronic unit, which is arranged at the integrated component, such as in particular the printed circuit board element or the MEMS component, or is bonded or soldered thereto or is integrated therein.

It is preferred for the coils integrated in the component to have windings formed by a spiral formed at a conductive layer of the component.

It is preferred for at least one excitation coil, a first measurement coil and a second measurement coil to have windings formed by a common conductor layer of the integrated component, such as in particular of the printed circuit board element or of the MEMS component.

It is preferred for a polymer to be injection-molded around the integrated component, such as e.g. the printed circuit board element or the MEMS component, with the integrated coils and the soft-magnetic cores.

The invention present here is suitable for various basic principles for the construction of the torque sensor including the design with yokes that cross one another, and also the design with a central flux concentrator.

Particularly preferably, the sensor head according to the invention has the construction as shown from DE 30 31 997 A1. A central excitation coil and a plurality of measurement pole pairs are preferably provided for this purpose.

Particularly preferably, at least two measurement pole pairs are provided; however, the sensor head also functions with three magnetic poles, that is to say for example one excitation pole and two measurement poles.

In accordance with a further aspect, the invention relates to a method for producing a sensor head for a magnetoelastic force or torque sensor for measuring a force or a torque in a ferromagnetic body, which sensor head comprises a magnetic field generating unit for generating a magnetic field in the ferromagnetic body and a magnetic field measuring unit for measuring a magnetic field change in the ferromagnetic body, wherein the magnetic field generating unit has an excitation coil and a soft-magnetic excitation flux amplifying element and the magnetic field measuring unit has a measurement coil and a soft-magnetic measurement flux amplifying element, comprising the following steps:
a) providing at least one printed circuit board, patterning a conductive layer of the printed circuit board in order to form windings of the excitation coil and of the measurement coil or
b) forming windings of the excitation coil and of the measurement coil in an integrated fashion by means of micromechanical manufacturing and/or patterning and/or additive manufacturing methods.

One preferred configuration of the invention provides a method for producing a sensor head for a magnetoelastic force or torque sensor for measuring a force or a torque in a ferromagnetic body, which sensor head comprises a magnetic field generating unit for generating a magnetic field in the ferromagnetic body and a magnetic field measuring unit for measuring a magnetic field change in the ferromagnetic body, wherein the magnetic field generating unit has an excitation coil around a soft-magnetic excitation core and the magnetic field measuring unit has a measurement coil around a soft-magnetic measurement magnetic pole core, comprising the following steps:
a) providing at least one printed circuit board and patterning a conductive layer of the printed circuit board in order to form windings of the excitation coil and of the measurement coil or
b) forming windings of the excitation coil and of the measurement coil in an integrated fashion by means of micromechanical manufacturing and/or patterning and/or by means of additive manufacturing methods.

It is preferred for step a) to contain: applying, in particular adhesively bonding, at least one ferritic film onto the printed circuit board in order to form the flux amplifying elements.

Preferably, the method comprising the following step:

producing the at least one ferritic film in a stamping process.

Preferably, the method comprises the following step:

providing the at least one ferritic film with a thickness of 0.1 mm to 3 mm, in particular 0.2 mm to 2 mm or 0.1 to 0.5 mm and 1 mm to 2 mm.

Preferably, the method comprises the following step:

providing a film composed of or comprising an iron oxide.

Preferably, step a) comprises: embedding a soft-magnetic material into the printed circuit board in order to form the cores or the flux amplifying elements.

Preferably, step b) comprises: forming windings of the excitation coil and of the measurement coil and of the soft-magnetic flux amplifying elements such as e.g. the cores in an integrated fashion by means of micromechanical manufacturing and/or patterning (MEMS) and/or by means of additive manufacturing methods.

Preferably, the method comprises:

providing a second printed circuit board comprising an incorporated soft-magnetic material for forming a magnetic circuit with the flux amplifying elements (e.g. cores) and connecting the first printed circuit board to the windings and the second printed circuit board in such a way that at least three magnetically interconnected magnetic poles having magnetic pole flux amplifiers and coils at least partly formed by the conductor layer of the first printed circuit board and assigned to the flux amplifying elements are formed.

Preferably, the method comprises:

providing a chip having a signal processing electronic unit and electrically connecting terminals of the chip to the coils in order to form a sensor package in this way.

Preferably, the method comprises:

injection molding a polymer material around at least the printed circuit board or the integral MEMS component formed by micromechanical manufacturing—with the coils and the flux amplifying elements.

One particular configuration of the invention relates to a sensor package comprising a magnetically-inductively measuring sensor element (preferably comprising coils and ferrite core), which is preferably integrated in a printed circuit board (pcb), and a likewise integrated signal processing electronic unit for the purpose of non-contact, magnetically inductive force or torque measurement in a ferromagnetic body. In this case, the entire package can optionally be encapsulated with a polymer by injection molding or be embodied as a “piggyback system”.

The chip packages thus obtainable are very attractive owing to costs and potential mass applications. Possible areas of use are e.g. e-bikes, e-wheelys, electric motors, torque vectoring and measuring of other forces, e.g. bending forces, tensile forces, or compressive forces.

In accordance with one configuration, the sensor head is produced using packaging methods. Technologies such as are known for the packaging of semiconductor components are preferably used. For further details, reference is explicitly made here to Wikipedia, “Electronic packaging”, retrieved on 25 Jul. 2016 and Wikipedia, “Semiconductor packaging” and “Integrated circuit packaging”, retrieved on 25 Jul. 2016.

Particularly preferably, the magnetic field generating unit and the magnetic field measuring unit are implemented in an integrated component by means of micromechanical manufacturing methods or by means of printed circuit board technology.

In particular, the coils can be produced as disc-type coils at conductor layers either additively or by removal of material. In particular, individual windings are produced in spiral form; a larger number of windings can be produced by connecting in series a plurality of spiral structures formed on different planes.

In this regard, a plurality of printed circuit boards having spiral structures can be stacked one on top of another and be interconnected with one another through vias. Moreover, soft-magnetic material for forming cores and yokes for the purpose of producing magnetic circuits, such as are shown in terms of their basic construction in U.S. Pat. No. 2,912,642, DE 30 31 997 A1, U.S. Pat. No. 4,503,714, 4,646,576 or 4,697,459, can also be produced by micromechanical and/or additive manufacturing methods.

Particularly preferably, a sensor head correspondingly produced by micromechanical and/or additive manufacturing methods contains a sensor packaging including an integrated circuit with an electronic signal processing unit.

The latter can be configured for example as an ASIC.

Exemplary embodiments of the invention are explained in greater detail below with reference to the accompanying drawings, in which:

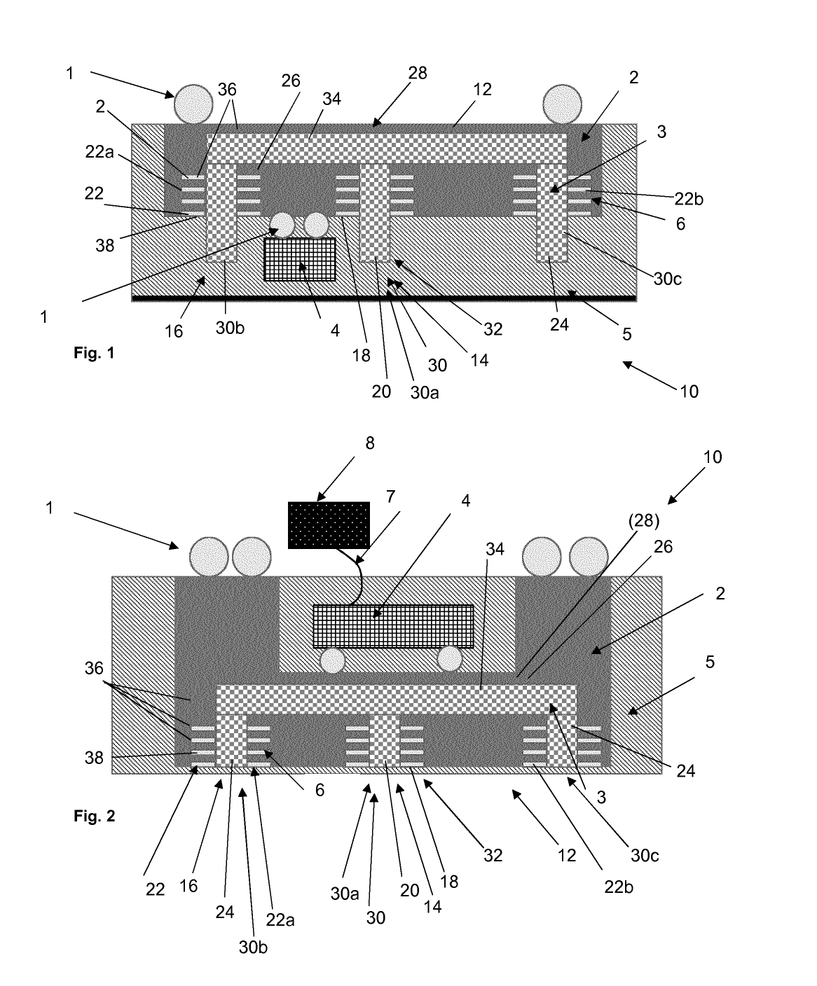

FIG. 1 shows a sectional illustration through a sensor head in accordance with a first embodiment;

FIG. 2 shows a sectional illustration through a sensor head in accordance with a second embodiment;

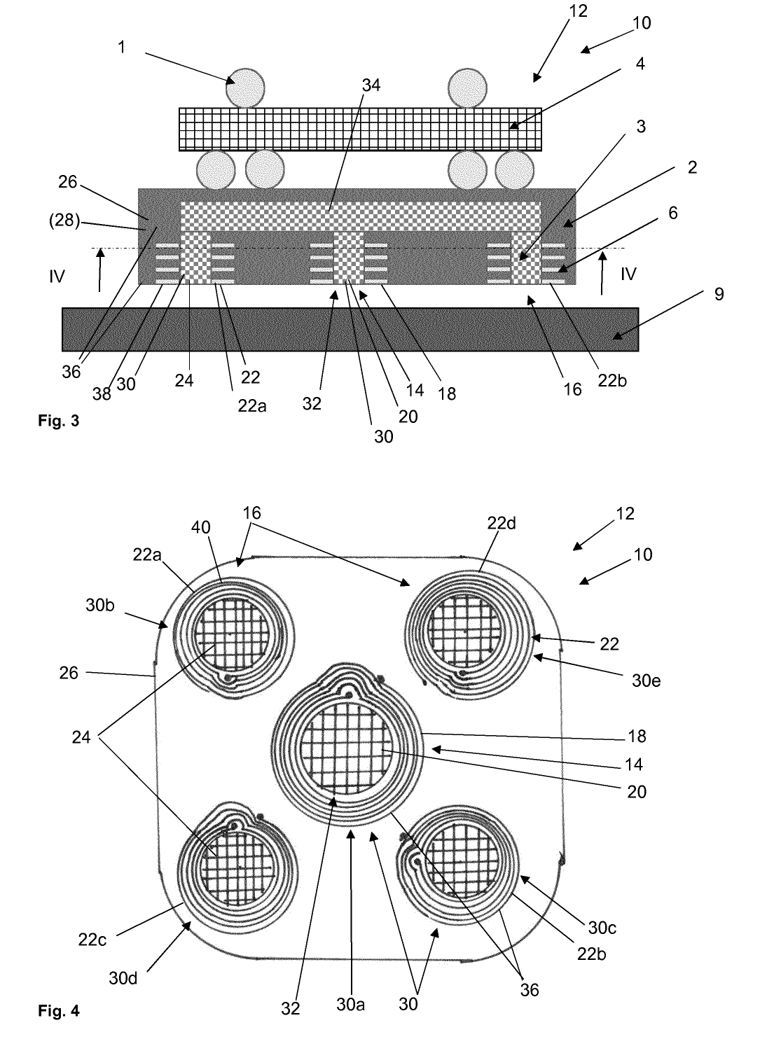

FIG. 3 shows a sectional illustration through a sensor head in accordance with a third embodiment;

FIG. 4 shows a section along the line IV-IV from FIG. 3 and

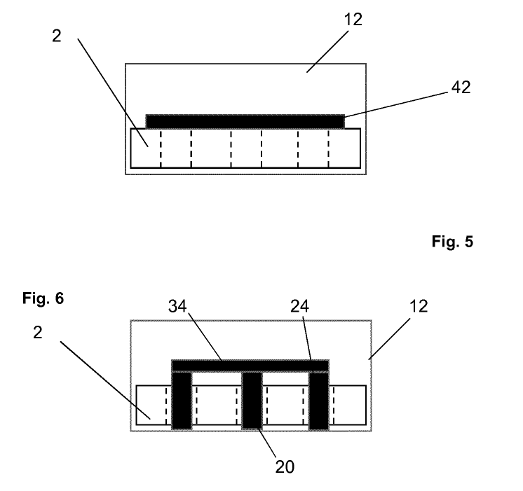

FIG. 5 shows a section through a further embodiment of a component for forming the sensor head; and

FIG. 6 shows a view as in FIG. 5 which shows the corresponding component from FIG. 5 in the configuration in accordance with the embodiments in FIGS. 1 to 4.

The figures show various embodiments of a sensor head 10 for a magnetoelastic force or torque sensor for measuring a force or a torque in a ferromagnetic body 9. The sensor head 10 is formed by a sensor package 12 constructed by means of packaging methods. The manufacturing is furthermore effected using micromechanical manufacturing methods (MEMS), additive manufacturing or printed circuit board technology. Combinations are also possible.

The sensor head 10 comprises a magnetic field generating unit 14 for generating a magnetic field in the ferromagnetic body 9 and a magnetic field measuring unit 16 for measuring a magnetic field change in the ferromagnetic body 9.

The magnetic field generating unit 14 has an excitation coil 18 and a flux amplifying element. In the configurations in FIGS. 1 to 4, the excitation coil 18 is provided around a soft-magnetic excitation core 20; at least one ferritic film 42 is provided in the configuration in FIG. 5 in order to form the flux amplifying element instead of the excitation core 20 or, in other embodiments (not illustrated), in addition to the excitation core 20.

The magnetic field measuring unit 16 has a plurality of measurement coils 22, each comprising a soft-magnetic flux amplifying element such as, in particular, a measurement core 24 or a region of at least one ferritic film 42.

The excitation coil 18 and the measurement coils 22 are constructed in an integrated fashion at a common printed circuit board element 26 and/or integrated component, in particular MEMS component 28.

The figures illustrate exemplary embodiments of the sensor head 10 having a total of five magnetic poles 30, wherein a central first magnetic pole 30a is part of the magnetic field generating unit 14 and has the excitation coil 18 and the excitation flux amplifying element such as the excitation core 20 or a region of the at least one ferritic film 42. The first magnetic pole 30a acts as a flux concentrator 32 for concentrating the magnetic flux generated by the excitation coil 18 in the surface of the measurement object 9 to be measured.

The further magnetic poles 30b to 30e are the poles of the magnetic field measuring unit 16. In the embodiments illustrated here, the magnetic field measuring unit 16 has in each case two magnetic pole pairs 30b-30c, 30d-30e for measuring the magnetic fields in different orientations. Another embodiment, not illustrated in more specific detail here, manages with only two magnetic poles of the magnetic field measuring unit 16; the fourth magnetic pole 30d and the fifth magnetic pole 30e are omitted here.

In the case of the embodiments illustrated in FIGS. 1 to 4, all the magnetic poles 30 are provided with cores, wherein the cores of the second to fifth magnetic poles form the measurement cores 24 and are surrounded by the respective measurement coils 22a to 22d. The core of the first magnetic pole 30a is the excitation core 20, which is surrounded by the measurement coil 22. All the cores 24, 20 are formed by soft-magnetic material. At least the cores of the magnetic pole pairs 30a-30b or 30c-30d of the magnetic field measuring unit 16 are connected to one another to form a yoke composed of soft-magnetic material. The soft-magnetic material is formed in particular by a ferrite core 3.

In the embodiments illustrated in FIGS. 1 to 4, all the magnetic poles 30a-30e are connected by the ferrite core 3; the latter can have a pot-shaped or star-shaped configuration, wherein the measurement cores 24 and respectively the excitation core 20 are formed by projections protruding in a corresponding fashion with respect to a direction, the respective coils 22, 22a-22d being provided around said projections.

The coils 22, 22a-22d are configured as coils 6 integrated in the integrated component, that is to say in particular in the printed circuit board element 26 or in the MEMS component 28.

In particular, the printed circuit board element 26 comprises at least one printed circuit board (PCB for short) comprising a carrier composed of insulating material and at least one conductor layer 38.

As evident from FIG. 4, the conductor layer 38 is patterned in such a way that windings 40 of the integrated coils 6 are formed. The windings 40 are formed in particular in a spiral fashion, wherein contact pads are formed at the ends, wherein one of the contact pads is led through a via through the insulation layer. By placing one on top of another and connecting in series a plurality of such printed circuit boards 36 having the correspondingly spirally formed windings 40, it is possible to form the integrated coils 6 having a multiplicity of windings 40.

The interior spaces centrally between the windings 40 can e.g. be drilled out and be filled with ferromagnetic material for forming the ferrite core 3.

The ferrite core can also be introduced into the sensor package 12 by means of additive manufacturing methods or by means of other packaging methods or micromechanical manufacturing methods. Overall, it is possible to construct the sensor head 10 comprising the integrated coils 6 and the ferromagnetic material for forming the yoke 34 and the cores 20, 24 by means of micromechanical manufacturing.

In all embodiments, the sensor package 12 furthermore comprises a signal processing electronic unit 4, in particular in the form of an integrated circuit, preferably in the form of an IC component, more particularly in the form of an ASIC, which is integrated into the sensor head 10. Packaging methods and/or micromechanical manufacturing methods are preferably used for this as well. Preferably, the signal processing electronic unit 4 is connected to the respective contacts of the integrated coils 6 by means of an array of solder balls 1.

The printed circuit board element 26 or the MEMS component 28 with the signal processing electronic unit 4 can be encapsulated by injection molding by means of a polymeric material, as is illustrated as injection-molding encapsulation 5 in the embodiments in FIGS. 1 and 2. FIG. 3 shows a “piggyback arrangement” of the printed circuit board element 26 or the MEMS component 28 with the integrated coils 6 and the integrated ferrite core 3 on the signal processing electronic unit 4.

The signal processing electronic unit 4 can be connected to an evaluation unit 8 by means of wire or cable 7 or some other conductive connection. Said evaluation unit (ECU—Electrical Control Unit) can contain a memory and a processor.

In order to direct the magnetic field in magnetically inductive sensors, a ferritic material is provided. In FIGS. 1 to 4, the use of customary materials such as e.g. sintered ferrites for forming flux amplifying elements such as, in particular, cores and yokes can be provided for this purpose. Sintered ferrites of this type have the disadvantage that the ferrites are brittle and rigid, that is to say that they cannot be produced in any shape and can be destroyed by mechanical shocks. Therefore, at least one ferritic film 42 as ferritic material is provided in the configuration in FIG. 5.

Here, in particular, a ferritic film 42 is provided for forming flux amplifying elements instead of the cores 20, 24 and/or for forming the yoke or instead of the yoke 34.

A ferritic film 42 can be produced with any desired size and dimensioning by means of a stamping process and be attached by adhesive bonding. The use of the ferritic film 42 makes it possible to achieve significantly more flexible dimensions in the configuration of the sensor.

The ferritic film has a diameter of a few 1/10 mm (up to 1-2 mm in the case of higher powers) and is also used for shielding purposes, that is to say that the susceptibility to interference of the low signals (typically in the two-digit mV range) is significantly reduced. Materials are typically iron oxides (like magnetic tape, material for audio tape cassettes or the like).

Otherwise, the component shown in FIG. 5 can have all features and elements explained with reference to the embodiments in FIGS. 1 to 4 and can be used in the sensor head 10. As a comparison with respect to FIG. 5, FIG. 6 shows the same view for the corresponding component comprising sintered ferrite, as can be used in the previous embodiments. As evident, the component in FIG. 5 can replace the corresponding components in FIGS. 1 to 4.

A comparison of FIGS. 5 and 6 also shows that the ferritic film 42 can extend spatially beyond the locations of the cores of the coils.

### LIST OF REFERENCE SIGNS

1 BGA Ball Grid Array, solder balls
2 PCB with integrated coil
3 Ferrite core incorporated in PCB
4 Signal processing electronic unit (ASIC)
5 Molding compound (injection molding encapsulation)
6 Integrated coils
7 Wire or cable (conductive connection)
8 Evaluation unit ECU (electrical control unit), memory, processor
9 Measurement object (shaft, cylinder, ferromagnetic body)
10 Sensor head
12 Sensor package
14 Magnetic field generating unit
16 Magnetic field measuring unit
18 Excitation coil
20 Excitation core
22 Measurement coil
22a First measurement coil
22b Second measurement coil
22c Third measurement coil
22d Fourth measurement coil
24 Measurement core
26 Printed circuit board element
28 MEMS component
30 Magnetic pole
30a First magnetic pole
30b Second magnetic pole
30c Third magnetic pole
30d Fourth magnetic pole
30e Fifth magnetic pole
32 Flux concentrator
34 Yoke
36 Printed circuit board
38 Conductor layer
40 Windings
42 Ferritic film

1. A sensor head (10) for a magnetoelastic force or torque sensor for measuring a force or a torque in a ferromagnetic body (9), comprising:
a magnetic field generating unit (14) for generating a magnetic field in the ferromagnetic body (9) and a magnetic field measuring unit (16) for measuring a magnetic field change in the ferromagnetic body (9),
wherein the magnetic field generating unit (14) has an excitation coil (18) and a soft-magnetic excitation flux amplifying element (20),
wherein the magnetic field measuring unit (16) has a plurality of measurement coils (22) with a soft-magnetic measurement flux amplifying element (24), and
wherein at least the excitation coil (18) and the measurement coils (22, 22a-22d) are integrated in a common integrated component (26, 28).

2. The sensor head according to claim 1, characterized
in that at least the excitation coil (18) and the measurement coils (22, 22a-22d) are integrated at a common printed circuit board element (26) and/or MEMS component (28).

3. The sensor head according to either of the preceding claims, characterized
in that the soft-magnetic excitation flux amplifying element is a soft-magnetic excitation core (20), around which the excitation coil (18) is arranged, and
in that the measurement coils (22) are provided with a soft-magnetic measurement core (24) as measurement flux amplifying element.

4. The sensor head (10) according to claim 3, characterized
in that the measurement cores (24) of a first measurement coil (22a) and of a second measurement coil (22b) are connected in order to form a magnetic circuit by means of a yoke (34) composed of soft-magnetic material, wherein the yoke (34) is at least partly incorporated or integrated into the integrated component (26, 28), and in particular is incorporated in a printed circuit board (36) or is integrated in a MEMS component (28).

5. The sensor head (10) according to either of claims 3 and 4, characterized
in that the excitation core (20) forms a flux concentrator (32), which is arranged as a central magnetic pole (30) between at least two measurement coils (22, 22a-22d).

6. The sensor head (10) according to claim 4 and according to claim 5, characterized
in that the excitation core (20) is contact-connected to the yoke (34).

7. The sensor head (10) according to any of the preceding claims, characterized
in that at least one ferritic film (42) is provided.

8. The sensor head (10) according to claim 7, characterized
in that the ferritic film (42) has a thickness of 0.1 mm to 3 mm, in particular 0.1 mm to 0.5 mm or 1 mm to 2 mm.

9. The sensor head (10) according to claim 7 or 8, characterized
in that the ferritic film (42) is embedded into the integrated component and/or is applied on the component and/or is fitted, in particular is adhesively bonded, onto a printed circuit board at which the coils are formed.

10. The sensor head (10) according to any of claims 7 to 9, characterized
in that the at least one ferritic film (42) forms at least one part of one of the soft-magnetic flux amplifying elements.

11. The sensor head (10) according to any of claims 7 to 10 and according to any of claims 4 to 6, characterized
in that the excitation core (20) and/or the measurement cores (24) and/or the yoke (34) are/is formed by the at least one ferritic film (42).

12. The sensor head (10) according to any of the preceding claims,
characterized by a first integrated component, in particular a first printed circuit board element (26) or a first MEMS component (28), at which at least the excitation coil (18) and a plurality of measurement coils (22, 22a-22d) are provided in an integrated fashion in such a way that a plurality of magnetic poles (30, 30a-30e) are formed, and by a second integrated component, in particular a second printed circuit board element (26) or a second MEMS component (28), into which is incorporated or integrated at least one soft-magnetic material for connecting and/or forming soft-magnetic cores of the magnetic poles (30, 30a-30e), wherein the first and second integrated components are connected to one another.

13. The sensor head (10) according to any of the preceding claims,
characterized by an integrated circuit, in particular an IC component, having a signal processing electronic unit (4), which is arranged at the integrated component, in particular the printed circuit board element (26) or the MEMS component (28), or is bonded or soldered thereto or is formed as an integrated part of the integrated component.

14. The sensor head (10) according to any of the preceding claims, characterized
in that the coils (6) integrated in the integrated component (26, 28) have windings (40) formed by a spiral formed at a conductive layer (38) of the integrated component (26, 28).

15. The sensor head (10) according to any of the preceding claims, characterized
in that at least one excitation coil (18), a first measurement coil (22a) and a second measurement coil (22b) have windings (40) formed by a common conductor layer (38) of the integrated component, in particular of the printed circuit board element (26) or of the MEMS component (28).

16. The sensor head (10) according to any of the preceding claims, characterized
in that a polymer is injection-molded around the integrated component with the integrated coils (6) and the soft-magnetic flux amplifying elements (20, 24, 34, 42).

17. A method for producing a sensor head (10) for a magnetoelastic force or torque sensor for measuring a force or a torque in a ferromagnetic body (9), which sensor head (10) comprises a magnetic field generating unit (14) for generating a magnetic field in the ferromagnetic body (9) and a magnetic field measuring unit (16) for measuring a magnetic field change in the ferromagnetic body (9), wherein the magnetic field generating unit (14) has an excitation coil (18) and a soft-magnetic excitation flux amplifying element (20, 42) and the magnetic field measuring unit (16) has a measurement coil (22, 22a-22d) and a soft-magnetic measurement flux amplifying element (24, 42), comprising the following steps:
a) providing at least one printed circuit board (36), patterning a conductive layer (38) of the printed circuit board (36) in order to form windings (40) of the excitation coil (18) and of the measurement coil (22, 22a-22d) or
b) forming windings (40) of the excitation coil (18) and of the measurement coil (22, 22a-22d) in an integrated fashion by means of micromechanical manufacturing and/or patterning and/or additive manufacturing methods.

18. The method according to claim 17, characterized
in that step a) contains: embedding a soft-magnetic material into the printed circuit board (36) in order to form the flux amplifying elements (20, 24) and/or
in that step b) contains: forming windings (40) of the excitation coil (18) and of the measurement coil (22, 22a-22d) and of the soft-magnetic cores in an integrated fashion by means of micromechanical manufacturing and/or patterning and/or additive manufacturing methods.

19. The method according to claim 17 or 18, characterized
in that step a) contains: applying, in particular adhesively bonding, at least one ferritic film (42) onto the printed circuit board (36) in order to form the flux amplifying elements (20, 24).

20. The method according to claim 19, characterized by at least one, a plurality or all of the following steps:
20.1 producing the at least one ferritic film (42) in a stamping process,
20.2 providing the at least one ferritic film with a thickness of 0.1 mm to 3 mm, in particular 0.1 mm to 2 mm or 0.1 mm to 0.5 mm and 1 mm to 2 mm,
20.3 providing a film (42) composed of or comprising an iron oxide.

21. The method according to one of the preceding claims, characterized by:
providing a second printed circuit board (36) comprising an incorporated soft-magnetic material for forming a magnetic circuit with coil cores (20, 24) and connecting the first printed circuit board (36) to the windings (40) and the second printed circuit board (36) in such a way that at least three magnetically interconnected magnetic poles (30, 30a-30e) having magnetic pole cores and coils (18, 20) at least partly formed by the conductor layer (38) of the first printed circuit board (36) and surrounding the coil cores (20, 24) are formed.

22. The method according to one of the preceding claims, characterized by
providing a chip having a signal processing electronic unit (4) and electrically connecting terminals of the chip to the coils (18, 22) in order to form a sensor package (12) in this way.

23. The method according to one of the preceding claims, characterized by injection molding (5) a polymer material around at least the printed circuit board (36) or the integral component (28) formed by micromechanical manufacturing with the coils (18, 22) and the flux amplifying elements (20, 24).
